(19) United States
(12) Patent Application Publication
(10) Pub. No.: US 2006/0106947 A1
(43) Pub. Date: May 18, 2006

(54) Information storage and retrieval system comprising a storage controller and a fibre channel switch controller

(76) Inventors: Michael T. Benhase, Tucson, AZ (US); Matthew D. Bomhoff, Tucson, AZ (US); Brian J. Cagno, Tucson, AZ (US); John C. Elliott, Tucson, AZ (US); Robert A. Kubo, Tucson, AZ (US); Gregg S. Lucas, Tucson, AZ (US)

Correspondence Address: DALE F. REGELMAN, 4231 S. FREMONT AVENUE, TUCSON, AZ, 85714, US

(21) Appl. No.: 10/994,123

(22) Filed: Nov. 18, 2004

(51) Int. Cl. G06F 3/00

(52) U.S. Cl. 710/2

(57) ABSTRACT

An information storage and retrieval system is disclosed, wherein that information storage and retrieval system comprises a storage controller, comprising one or more host adapter ports, one or more device adapter ports, a processor, and a Fibre Channel switch. The information storage and retrieval system further comprises a Fibre Channel switch controller consisting essentially of a Fibre Channel switch and a processor. The system further comprises a plurality of data storage devices, where each of those data storage devices is interconnected with the storage controller and with the Fibre Channel switch controller.

### FIELD OF THE INVENTION

This invention relates to an information storage and retrieval system comprising a storage controller and a Fibre Channel switch controller.

### BACKGROUND OF THE INVENTION

Data storage and retrieval systems are used to store information provided by one or more host computer systems. Such data storage and retrieval systems receive requests to write information to one or more data storage devices, and requests to retrieve information from those one or more data storage devices. Upon receipt of a write request, the system stores information received from a host computer in a data cache. In certain implementations, a copy of that information is also stored in a nonvolatile storage device. Upon receipt of a read request, the system recalls information from the one or more data storage devices and moves that information to the data cache. Thus, the system is continuously moving information to and from data storage devices, and to and from the data cache.

What is needed, for the reasons set forth herein, is an information storage and retrieval system which comprises two controllers, where one of those system controller comprises a storage controller and where the other of those two controllers does not comprise a storage controller.

### SUMMARY OF THE INVENTION

Applicants' invention comprises an information storage and retrieval system, comprising a storage controller, comprising one or more host adapter ports, one or more device adapter ports, a Fibre Channel initiator, and a first Fibre Channel switch. The information storage and retrieval system further comprises a Fibre Channel switch controller consisting essentially of a second Fibre Channel switch. The information storage and retrieval system further comprises a plurality of data storage devices, where each of those data storage devices is interconnected with the storage controller and with the Fibre Channel switch controller.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing Applicants' data storage and retrieval system;

FIG. 2 is a block diagram showing a first prior art information storage and retrieval system which comprises two storage controllers and a plurality of data storage devices;

FIG. 3 is a block diagram showing a second prior art information storage and retrieval system which comprises two storage controllers and a first, a second, and a third, plurality of data storage devices;

FIG. 4 is a block diagram showing a first embodiment of Applicants' information storage and retrieval system which comprises one storage controller, one Fibre Channel switch controller, and a plurality of data storage devices;

FIG. 5 is a block diagram showing the system of FIG. 3 without one of the two storage controllers;

FIG. 6 is a block diagram showing a second embodiment of Applicants' information storage and retrieval system which comprises one storage controller, one Fibre Channel switch controller, and a plurality of data storage devices.

### DETAILED DESCRIPTION OF THE PREFERRED EMBODIMENTS

This invention is described in preferred embodiments in the following description with reference to the Figures, in which like numbers represent the same or similar elements. The invention will be described as embodied in an information storage and retrieval system which comprises two clusters, a plurality of host adapter ports, a plurality of device adapter ports, and a data cache.

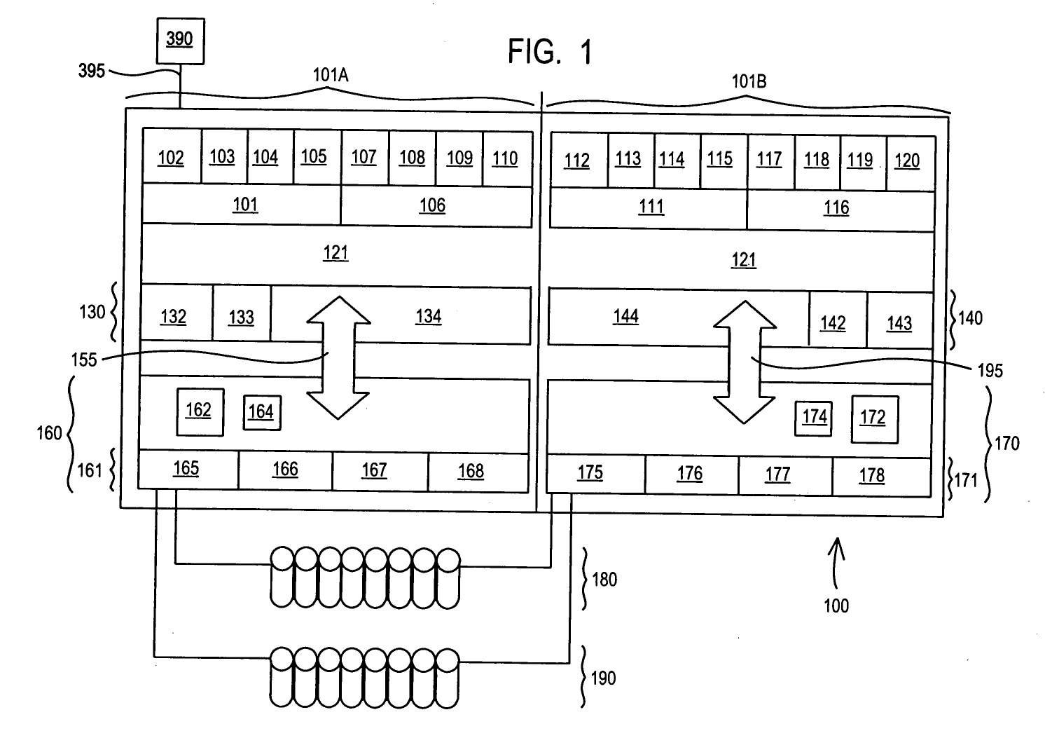

Referring now to FIG. 1, information storage and retrieval system 100 is capable of communication with host computer 390 via communication link 395. The illustrated embodiment of FIG. 1 shows a single host computer. In other embodiments, Applicants' information storage and retrieval system is capable of communicating with a plurality of host computers.

Host computer 390 comprises a computer system, such as a mainframe, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; and UNIX is a registered trademark in the United States and other countries licensed exclusively through The Open Group.) In certain embodiments, host computer 390 further comprises a storage management program. The storage management program in the host computer 390 may include the functionality of storage management type programs known in the art that manage the transfer of data to a data storage and retrieval system, such as the IBM DFSMS implemented in the IBM MVS operating system.

In certain embodiments, Applicants' information storage and retrieval system 100 comprises a first plurality of host adapter ports 101 which comprises adapters 102-105 and 107-110; and a second plurality of host adapter ports 111 which comprises adapters 112-115 and 117-120. In other embodiments, Applicants' information storage and retrieval system comprises fewer than 16 host adapter ports. In still other embodiments, Applicants' information storage and retrieval system comprises more than 16 host adapter ports.

Regardless of the number of host adapter ports disposed in any embodiments of Applicants' system, each of those host adapter ports comprises a shared resource that has equal access to both central processing/cache elements 130 and 140. Each host adapter port may comprise one or more Fibre Channel ports, one or more FICON ports, one or more ESCON ports, or one or more SCSI ports, or one or more iSCSI ports. Each host adapter port is connected to both clusters through interconnect bus 121 such that each cluster can handle I/O from any host adapter port. Internal buses in each subsystem are connected via a Remote I/O bridge 155/195 between the processor portions 130/140 and I/O portions 160/170, respectively.

Processor portion 130 comprises processor 132 and cache 134. In certain embodiments, processor portion 130 further comprises memory 133. In certain embodiments, memory device 133 comprises random access memory. In certain embodiments, memory device 133 comprises non-volatile memory.

Processor portion 140 comprises processor 142 and cache 144. In certain embodiments, processor portion 140 further comprises memory 143. In certain embodiments, memory device 143 comprises random access memory. In certain embodiments, memory device 143 comprises non-volatile memory.

I/O portion 160 comprises a plurality of device adapter ports 161 which in the illustrated embodiment of FIG. 1 comprises device adapter ports 165, 166, 167, and 168. I/O portion 160 further comprise nonvolatile storage (“NVS”) 162 and battery backup 164 for NVS 162.

I/O portion 170 comprises a plurality of device adapter ports 171 which in the illustrated embodiment of FIG. 1 comprises device adapter ports 175, 176, 177, and 178. I/O portion 170 further comprise nonvolatile storage (“NVS”) 172 and battery backup 174 for NVS 172.

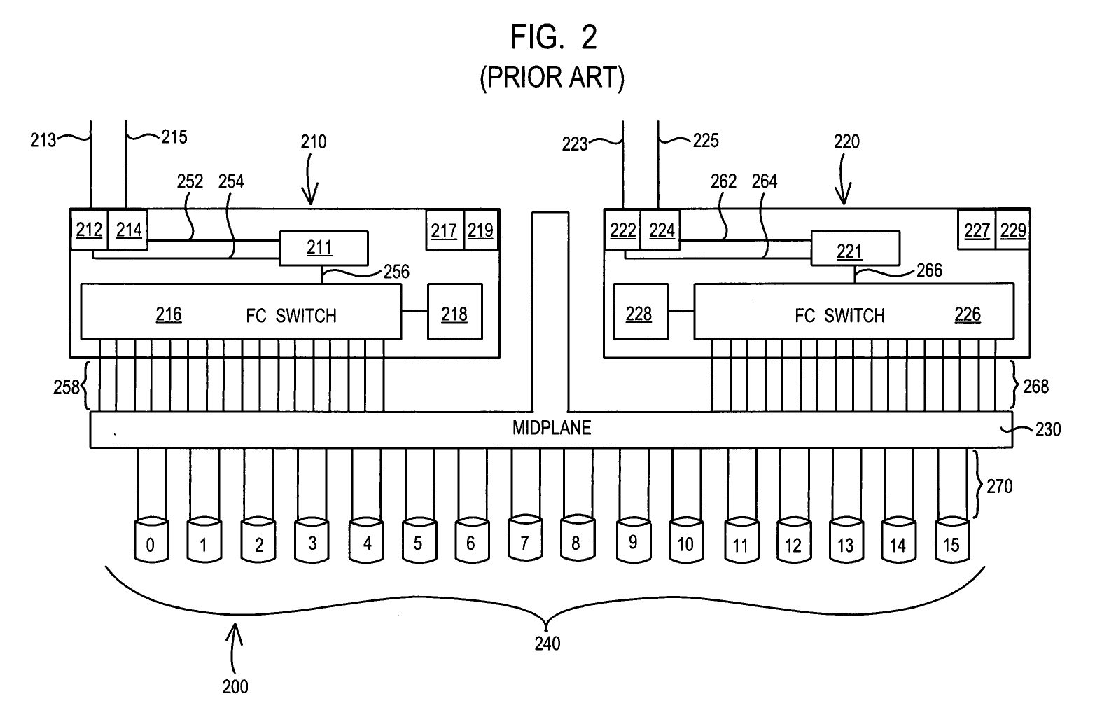

In certain embodiments of Applicants' system, one or more host adapter ports 101, processor portion 130, and one or more device adapter ports 161, are disposed in a single controller, such as controller 210 (FIG. 2) disposed in Applicants' information storage and retrieval system. Similarly, in certain embodiments, one or more host adapter ports 111, processor portion 140, and one or more device adapter ports 171, are disposed on second controller, such as controller 220, disposed in Applicants' information storage and retrieval system. In these embodiments, Applicants' system 100 comprises two controllers.

In the illustrated embodiment of FIG. 1, sixteen data storage devices are organized into two arrays, namely array 180 and array 190. The illustrated embodiment of FIG. 1 shows two storage device arrays. Each storage array appears to a host computer as one or more logical devices.

In certain embodiments, one or more of the data storage devices comprise a plurality of hard disk drive units. In certain embodiments, arrays 180 and 190 utilize a RAID protocol. In certain embodiments, arrays 180 and 190 comprise what is sometimes called a JBOD array, i.e. “Just a Bunch Of Disks” where the array is not configured according to RAID. In still other embodiments, arrays 180 and 190 comprise what is sometimes called a SBOD array, i.e. “Switched Bunch Of Disks,” where those arrays are not configured according to RAID.

The illustrated embodiment of FIG. 1 shows two storage device arrays. In other embodiments, Applicants' system comprises a single storage device array. In yet other embodiments, Applicants' system comprises more than two storage device arrays.

Referring now to FIG. 2, certain prior art storage systems comprise two storage controllers in combination with a plurality of data storage devices. Prior art system 200 further comprises a midplane interconnecting two storage controllers to one or more data storage devices. Midplane 230 interconnects a plurality of data storage devices 240 with storage controllers 210 and 220. Each of the plurality of data storage devices 240 comprises two Fibre Channel ports. In the illustrated embodiment of FIG. 2, each of two Fibre Channel ports disposed on each of the plurality of data storage devices 240 are used to interconnect each of the plurality of data storage devices 240 to storage controllers 210 and 220 via midplane 230. As those skilled in the art will appreciate, use of both Fibre Channel ports on each of the plurality of data storage devices 240 provides two I/O paths to read and/or write information from and/or to each of those data storage devices.

In the illustrated embodiment of FIG. 2, storage controller 210 comprises host adapter port 212, host adapter port 214, Fibre Channel switch 216, processor 218, device adapter port 217, and device adapter port 219. Storage controller 210 further comprises storage logic 211 interconnected with host adapter port 212, host adapter port 214, and Fibre Channel switch 216 by communication links 252, 254, and 256, respectively. Storage logic 211 receives host commands, and optionally host data payloads, and directs those host commands and those optional host data payloads to Fibre Channel switch 216 with commands to provide those host commands and optionally host data payloads to one or more designated data storage devices, such as one or more of data storage devices 240.

In certain embodiments, processor 218 comprises an SES processor. In certain embodiments, that SES processor comprises a Fibre Channel initiator. In other embodiments, Applicants' storage controller 210 comprises more than two host adapter ports, and/or more that two device adapter ports.

Communication link 213 interconnects host adapter port 212 to one or more host computers. Communication link 215 interconnects host adapter port 214 to one or more host computers.

In the illustrated embodiment of FIG. 2, storage controller 220 comprises host adapter port 222, host adapter port 224, Fibre Channel switch 226, processor 228, device adapter port 227, and device adapter port 229. Storage controller 220 further comprises storage logic 221 interconnected with host adapter port 222, host adapter port 224, and Fibre Channel switch 226 by communication links 262, 264, and 266, respectively. Storage logic 221 receives host commands, and optionally host data payloads, and directs those host command and those optional host data payloads to Fibre Channel switch 226 with commands to provide those host commands and optionally host data payloads to one or more designated data storage devices, such as one or more of data storage devices 240.

In certain embodiments, processor 228 comprises an SES processor. In certain embodiments, that SES processor comprises a Fibre Channel initiator. In other embodiments, Applicants' storage controller 220 comprises more than two host adapter ports, and/or more that two device adapter ports.

Fibre Channel switch 216 is interconnected to midplane 230 by plurality of communication links 258. Fibre Channel switch 226 is interconnected to midplane 230 by plurality of communication links 268. Midplane 230 is interconnected to plurality of data storage devices 240 by plurality of communication links 270.

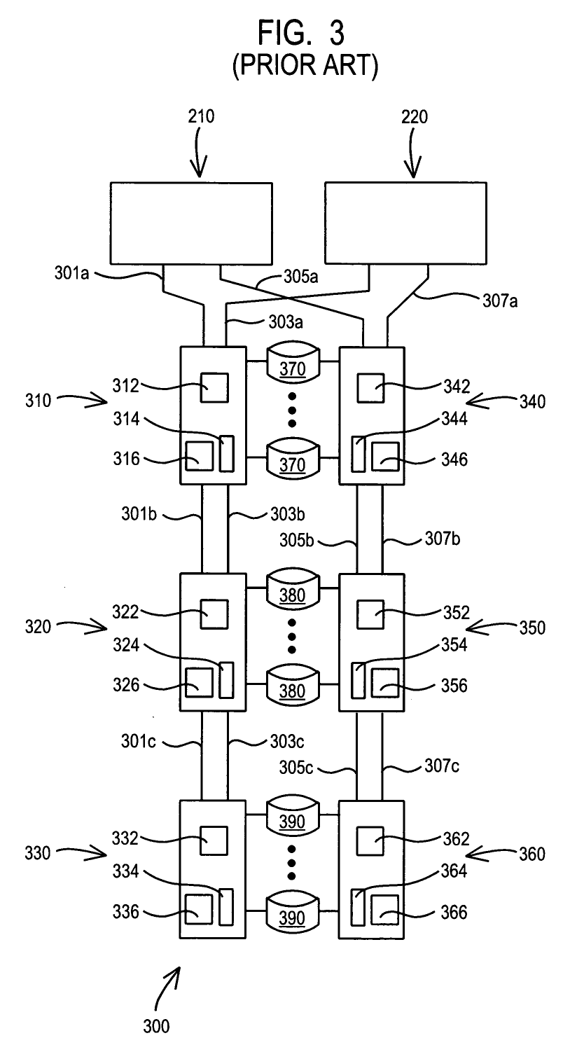

Referring now to FIG. 3, prior art information storage and retrieval system 300 comprises dual Fibre Channel arbitrated loops (“FC-AL”) comprising a plurality of Fibre Channel switches where storage controllers 210 and 220 are each connected to two FC-AL loops. Each loop contains a plurality of switch domain control cards, such as switch domain control cards 310, 320, 330, 340, 350, and 360.

Each switch domain control card comprises a switch and a processor. In certain embodiments, the switch comprises a Fibre Channel switch. In certain embodiments, the processor comprises an SES processor. In the illustrated embodiment of FIG. 3, switch domain controllers 310, 320, 330, 340, 350, and 360, comprise processors 312, 322, 332, 342, 352, and 362, respectively. In the illustrated embodiment of FIG. 3, switch domain controllers 310, 320, 330, 340, 350, and 360, include switches 314, 324, 334, 344, 354, and 364, respectively. In the illustrated embodiment of FIG. 3, switch domain controllers 310, 320, 330, 340, 350, and 360, include microcode 316, 326, 336, 346, 356, and 366, respectively.

In the illustrated embodiment of FIG. 3, each of the plurality of data storage devices 370, and each of the plurality of data storage devices 380, and each of the plurality of data storage devices 390, can be accessed through two different Fibre Channel switches disposed in two different switch domain controllers. As those skilled in the art will appreciate, use of both Fibre Channel ports on each of the plurality of data storage devices 370, 380, and 390, provides two I/O paths to read and/or write information from and/or to each of the data storage devices.

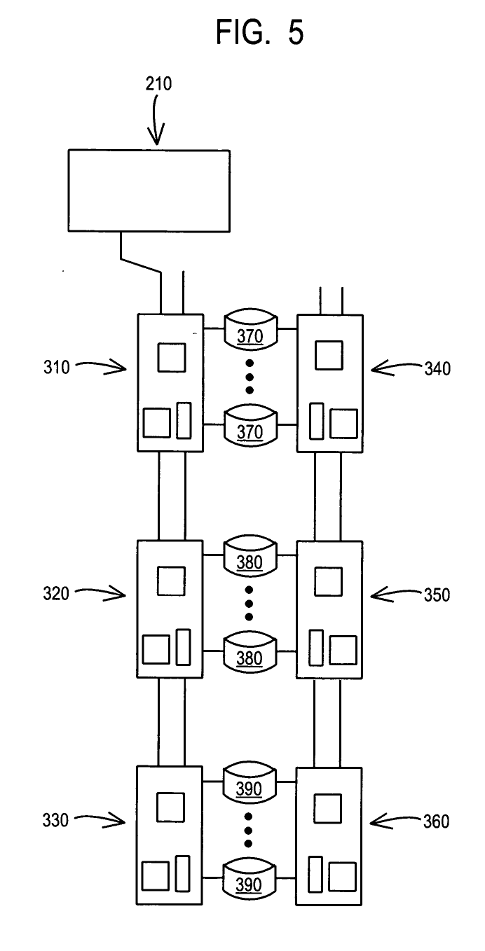

Referring to FIGS. 3 and 5, the illustrated embodiment of FIG. 5 comprises the system shown in FIG. 3 wherein one of the two storage controllers has been removed. In the illustrated embodiment of FIG. 3, each of the plurality of data storage devices 370, and each of the plurality of data storage devices 380, and each of the plurality of data storage devices 390, are disposed in two different switch domains, i.e. each of the two Fibre Channel ports on each data storage device are accessed through a different Fibre Channel switch disposed in a different switch domain controller. In the illustrated embodiment of FIG. 5, each of the plurality of data storage devices 370, and each of the plurality of data storage devices 380, and each of the data storage devices 390, are disposed in a single switch domain, i.e. one available Fibre Channel port on each data storage device is not used.

As those skilled in the art will appreciate, removing one of the two storage controllers from information storage and retrieval system 300 results in a cost reduction. Although removal of one of two storage controllers results in a cost reduction, that cost reduction carries with it a performance reduction in that each data storage device disposed in the system is available through a single I/O path comprising a single Fibre Channel port. Therefore such a prior art single storage controller implementation cannot take advantage of the dual ported nature of the FC-AL drives which provides availability when one drive port is failed.

In certain embodiments, Applicants' information storage and retrieval system 100 comprises a storage controller in combination with a Fibre Channel switch controller, where each of those controllers is interconnected to a plurality of data storage devices, wherein each of those data storage devices comprises two Fibre Channel ports, and wherein each of the two Fibre Channel ports are utilized to provide two I/O paths to each of the data storage devices.

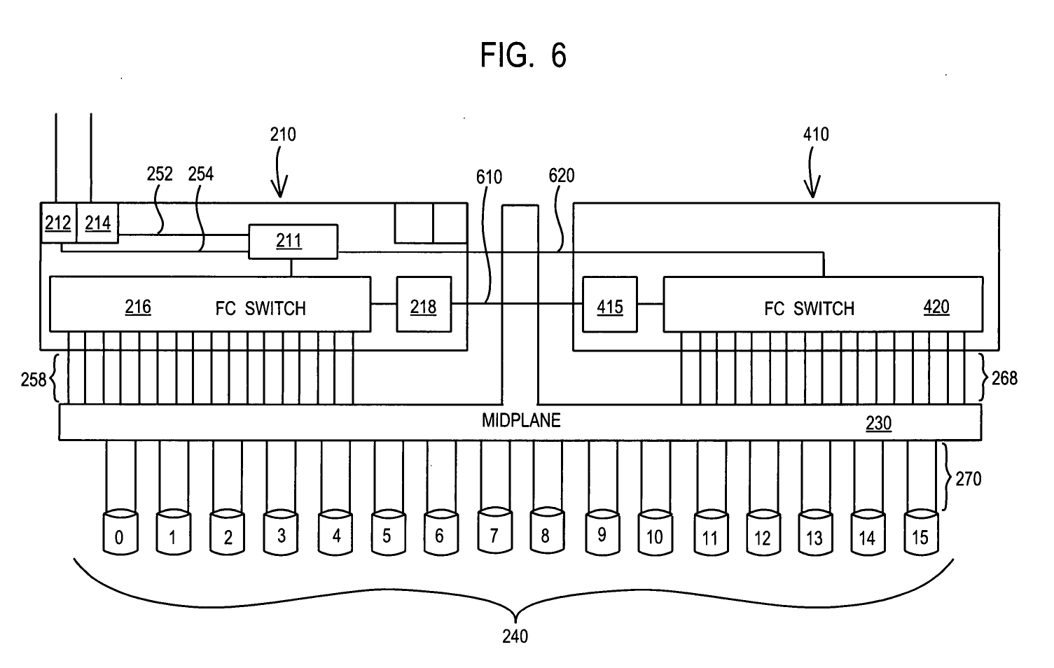

For example, in the illustrated embodiment of FIG. 6, Applicants' information storage and retrieval system comprises storage controller 210 in combination with Fibre Channel switch controller 410. Fibre Channel switch controller 410 comprises Fibre Channel switch 420, and processor 415. Fibre Channel switch controller 410 does not comprise any host adapter ports, does not comprise any device adapter ports, and does not comprise storage logic.

Processor 218, disposed in storage controller 210 is interconnected to processor 415, disposed in the Fibre Channel switch controller 410, by communication link 610. Storage logic 211, disposed in storage controller 210, is interconnected to Fibre Channel switch 420, disposed in Fibre Channel switch controller 410, by communication link 620.

A plurality of communication links, such as links 258, interconnect Fibre Channel switch 216, disposed in storage controller 210 to midplane 230. A plurality of communication links 268 interconnect the Fibre Channel switch 420 to midplane 230. A plurality of communication links 270 interconnect each of two Fibre Channel ports disposed on each of the storage devices comprising plurality of data storage devices 240 to midplane 230.

In the illustrated embodiment of FIG. 6, Applicants' information storage and retrieval system comprises a storage controller and a Fibre Channel switch controller, where those controllers are each interconnected with a plurality of data storage devices each comprising two Fibre Channel ports, such that both Fibre Channel ports of each of the plurality of data storage devices can be accessed by a different one of two Fibre Channel switches, wherein a first one of those Fibre Channel switches is disposed in the storage controller, and wherein a second one of those Fibre Channel switches is disposed in the Fibre Channel switch controller. This being the case, each data storage device comprising a plurality of data storage devices 240 is disposed in two different switch domains, wherein a first switch domain comprises the Fibre Channel switch disposed in the storage controller, and wherein a second switch domain comprises the Fibre Channel switch disposed in the Fibre Channel switch controller.

A storage services provider offering storage services to storage services customers utilizing the apparatus of FIG. 6 is able to provide cost-effective storage services. The purchase or lease price of an information storage and retrieval system, such as the systems of FIG. 6, comprising one storage controller, such as storage controller 210, in combination with one Fibre Channel switch controller, such as controller 410, is less than the purchase or lease price of an information storage and retrieval system comprising two storage controllers, such as the system of FIG. 2. The system of FIG. 6 nonetheless provides two I/O paths to each of the data storage devices disposed therein. Using the system of FIG. 6, a storage services provider is able to provide cost-effective storage services.

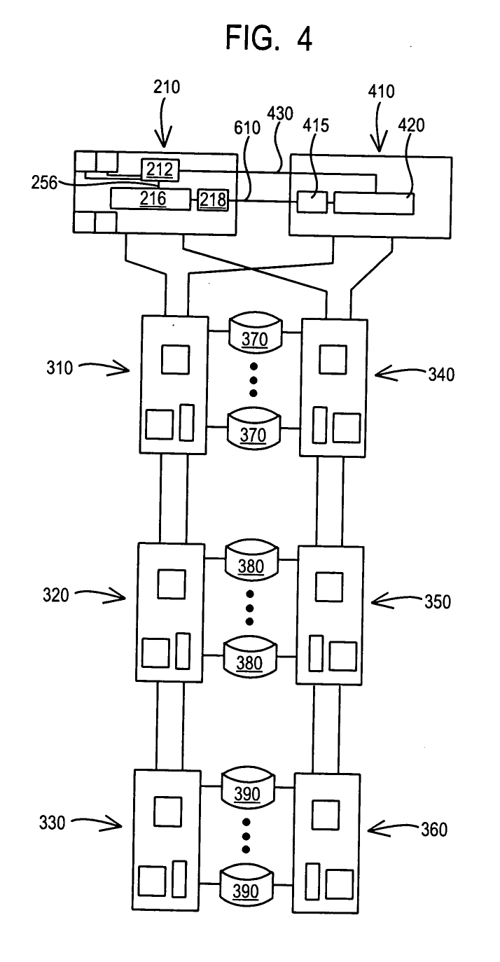

In certain embodiments, Applicants' information storage and retrieval system 100 comprises a storage controller, such as storage controller 210, a Fibre Channel switch controller, such as system controller 410, where each of those controllers is interconnected to dual Fibre Channel arbitrated loops (“FC-AL”), where each of those Fibre Channel loops comprises a plurality of switch domain controllers. In the illustrated embodiment of FIG. 4, the storage controller and the Fibre Channel switch controller are interconnected via dual Fibre Channel loops to switch domain controllers 310, 320, 330, 340, 350, and 360.

Further in the illustrated embodiment of FIG. 4, storage logic 211 is interconnected to both Fibre Channel switch 216, disposed in controller 210, and to Fibre Channel switch 420, by communication links 256 and 430, respectively. SES processor 218 is interconnected with SES processor 415 by communication link 610.

In the illustrated embodiment of FIG. 4, each of the plurality of data storage devices 370, and each of the plurality of data storage devices 380, and each of the plurality of data storage devices 390, comprise two Fibre Channel ports. Moreover in the illustrated embodiment of FIG. 4, each of the plurality of data storage devices 370, and each of the plurality of data storage devices 380, and each of the plurality of data storage devices 390, are disposed in two different switch domains.

For example, each of plurality of data storage devices 370 is disposed in a first switch domain comprising switch domain controller 310, and in a second switch domain comprising switch domain controller 340. Similarly, each of plurality of data storage devices 380 is disposed in a first switch domain comprising switch domain controller 320, and in a second switch domain comprising switch domain controller 350. In addition, each of plurality of data storage devices 390 is disposed in a first switch domain comprising switch domain controller 330, and in a second switch domain comprising switch domain controller 360.

Information can be read from, and/or written to, each of plurality of data storage devices 370 via two different I/O paths, wherein a first I/O path is disposed in a first switch domain comprising switch domain controller 310, and wherein a second I/O path is disposed in a second switch domain comprising switch domain controller 340. Similarly, information can be read from, and/or written to, each of plurality of data storage devices 380 via two different I/O paths, wherein a first I/O path is disposed in a first switch domain comprising switch domain controller 320, and wherein a second I/O path is disposed in a second switch domain comprising switch domain controller 350. In addition, information can be read from, and/or written to, each of plurality of data storage devices 390 via two different I/O paths, wherein a first I/O path is disposed in a first switch domain comprising switch domain controller 330, and wherein a second I/O path is disposed in a second switch domain comprising switch domain controller 360.

A storage services provider offering storage services to storage services customers utilizing the apparatus of FIG. 4 is able to provide cost-effective storage services. The purchase or lease price of an information storage and retrieval system, such as the systems of FIG. 4, comprising one storage controller, such as storage controller 210, in combination with one Fibre Channel switch controller, such as controller 410, is less than the purchase or lease price of an information storage and retrieval system comprising two storage controllers, such as the system of FIG. 3. The system of FIG. 4 nonetheless provides two I/O paths to each of the data storage devices disposed therein. Using the system of FIG. 4, a storage services provider is able to provide cost-effective storage services.

While the preferred embodiments of the present invention have been illustrated in detail, it should be apparent that modifications and adaptations to those embodiments may occur to one skilled in the art without departing from the scope of the present invention as set forth in the following claims.

We claim:

1. An information storage and retrieval system, comprising:
a storage controller, comprising one or more host adapter ports, one or more device adapter ports, storage logic, a first processor, and a first Fibre Channel switch;
a Fibre Channel switch controller consisting essentially of a second Fibre Channel switch and a second processor;
a first plurality of data storage devices, wherein each of said first plurality of data storage devices is interconnected with said storage controller and with said Fibre Channel switch controller.

2. The information storage and retrieval system of claim 1, wherein said first controller further comprises an SES processor.

3. The information storage and retrieval system of claim 1, wherein said Fibre Channel switch controller does not comprise one or more host adapter ports.

4. The information storage and retrieval system of claim 1, wherein said Fibre Channel switch controller does not comprise storage logic.

5. The information storage and retrieval system of claim 1, wherein each of said first plurality of data storage devices comprises a first Fibre Channel port and a second Fibre Channel port, wherein a first Fibre Channel port disposed on each data storage device interconnects that data storage devices to a first switch domain, and wherein a second Fibre Channel port disposed on each data storage device interconnects that data storage device to a second switch domain.

6. The information storage and retrieval system of claim 5, further comprising a midplane, wherein said first Fibre Channel switch and said second Fibre Channel switch are interconnected to said midplane and wherein each of said first plurality of data storage devices is interconnected to said midplane.

7. The information storage and retrieval system of claim 6, wherein a first Fibre Channel port disposed on each of said first plurality of data storage devices is interconnected to said midplane by a first communication link, and wherein a second Fibre Channel port disposed on each of said first plurality of data storage devices is interconnected to said midplane by a second communication link.

8. The information storage and retrieval system of claim 7, wherein said first switch domain comprises a plurality of first Fibre Channel ports, a plurality of first communication links, said midplane and said storage controller, and wherein said second switch domain comprises a plurality of second Fibre Channel ports, a plurality of second communication links, said midplane and said Fibre Channel switch controller.

9. The information storage and retrieval system of claim 1, further comprising:
a second plurality of data storage devices;
a first Fibre Channel arbitrated loop interconnecting said second plurality of data storage devices and said storage controller.

10. The information storage and retrieval system of claim 9, further comprising a first switch domain Fibre Channel switch interconnected to each of said second plurality of data storage devices, wherein said first Fibre Channel arbitrated loop interconnects said first switch domain Fibre Channel switch and said storage controller.

11. The information storage and retrieval system of claim 10, further comprising a first switch domain controller comprising said first switch domain Fibre Channel switch and a first switch domain processor.

12. The information storage and retrieval system of claim 11, wherein each of said second plurality of data storage devices is disposed in a second switch domain comprising said second plurality of data storage devices and said first switch domain controller.

13. The information storage and retrieval system of claim 10, wherein each of said second plurality of data storage devices comprises:
a first Fibre Channel port;
a first communication link interconnecting said first switch domain Fibre Channel switch and said first Fibre Channel port.

14. The information storage and retrieval system of claim 9, further comprising a second Fibre Channel arbitrated loop interconnecting said second plurality of data storage devices and said Fibre Channel switch controller.

15. The information storage and retrieval system of claim 14, further comprising a second switch domain Fibre Channel switch interconnected to each of said second plurality of data storage devices, wherein said second Fibre Channel arbitrated loop interconnects said second switch domain Fibre Channel switch and said Fibre Channel switch controller.

16. The information storage and retrieval system of claim 15, further comprising a second switch domain controller comprising said second switch domain Fibre Channel switch and a second switch domain processor.

17. The information storage and retrieval system of claim 16, wherein each of said second plurality of data storage devices is disposed in a second switch domain comprising said second plurality of data storage devices and said second switch domain controller.

18. The information storage and retrieval system of claim 15, wherein each of said second plurality of data storage devices comprises:
a second Fibre Channel port;
a second communication link interconnecting said second switch domain Fibre Channel switch and said second Fibre Channel port.

19. The information storage and retrieval system of claim 18, further comprising a midplane, wherein said first switch domain Fibre Channel switch and said second switch domain Fibre Channel switch are interconnected to said midplane and wherein each of said second plurality of data storage devices is interconnected to said midplane.

20. The information storage and retrieval system of claim 19, wherein each of said second plurality of data storage devices comprises a first Fibre Channel port interconnected to said midplane by a first communication link, and wherein each of said second plurality of data storage devices comprises a second Fibre Channel port interconnected to said midplane by a second communication link.

21. The information storage and retrieval system of claim 20, wherein each of said second plurality of data storage devices is disposed in a first switch domain comprising said first Fibre Channel port, said first communication link, said midplane and said first switch domain Fibre Channel switch, and wherein each of said second plurality of data storage devices is disposed in a second switch domain comprising said second Fibre Channel port, said second communication link, said midplane and said second switch domain Fibre Channel switch.

22. A method to provide cost-effective storage services, comprising the steps of:
providing storage services to one or more storage services customers using an information storage and retrieval system, comprising:
a storage controller, comprising one or more host adapter ports, one or more device adapter ports, storage logic, a first processor, and a first Fibre Channel switch;
a Fibre Channel switch controller consisting essentially of a second Fibre Channel switch and a second processor;
a first plurality of data storage devices, wherein each of said first plurality of data storage devices is interconnected with said storage controller and with said Fibre Channel switch controller.

23. The method of claim 22, wherein said first controller further comprises an SES processor.

24. The method of claim 22, wherein said Fibre Channel switch controller does not comprise one or more host adapter ports.

25. The method of claim 22, wherein said Fibre Channel switch controller does not comprise storage logic.
